(19) United States
(12) Patent Application Publication
(10) Pub. No.: US 2014/0304133 A1
(43) Pub. Date: Oct. 9, 2014

(54) TICKER TILES

(71) Applicant: TD AMERITRADE IP COMPANY, IP, Omaha, NE (US)

(72) Inventor: Basil LA RODA, II, Omaha, NE (US)

(21) Appl. No.: 13/857,034

(22) Filed: Apr. 4, 2013

(51) Int. Cl. G06Q 40/04

(52) U.S. Cl. CPC G06Q 40/04
USPC 705/37

(57) ABSTRACT

Methods, systems, and apparatuses, including computer programs encoded on computer-readable media, for receiving configuration data comprising an indication of a first security or index, an original price of the first security or index, and a first audio indicator type. Pricing data of the first security or index is received and a change in price of the first security or index is determined based upon the received pricing data and the original price. A first audio property of a first audio indicator is determined based upon the change in price and the first audio indicator type, and the first audio indicator is played.

### BACKGROUND

Ticker tape machines printed near real-time prices for stocks, market indexes, and other securities on ticker tape. A person watching the ticker tape could gain an understanding of the how the market, stocks, or other securities were moving. In today's trading platforms, ticker tape has been replaced with displays. A user's display can show current price information, along with other data. While the technology of providing price information to users has changed, current price information is still relayed to users using visual descriptions.

### SUMMARY

In general, one aspect of the subject matter described in this specification can be embodied in methods for receiving configuration data comprising an indication of a first security or index, an original price of the first security or index, and a first audio indicator type. Pricing data of the first security or index is received and a change in price of the first security or index is determined based upon the received pricing data and the original price. A first audio property of a first audio indicator is determined based upon the change in price and the first audio indicator type, and the first audio indicator is played. Other implementations of this aspect include corresponding systems, apparatuses, and computer-readable media configured to perform the actions of the method.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims. Like reference numbers and designations in the various drawings indicate like elements.

FIG. 1 illustrates a ticker tile on a display in accordance with an illustrative implementation.

FIG. 2 illustrates multiple ticker tiles on a display in accordance with an illustrative implementation.

FIG. 3 is a flow diagram of a process for providing an audio indication in accordance with an illustrative implementation.

FIG. 4 is a block diagram of a computer system in accordance with an illustrative implementation.

### DETAILED DESCRIPTION

A ticker tile is an application that provides an audio indicator of the movement of a market, stock, or other security based upon pricing data. In addition to an audio indicator, a ticker tile can have one or more visual indicators. For example, the ticker tile can change color based upon movement of a security and/or include pricing data associated with the security. Pricing data can include data such as, but not limited to, a current bid price, a current ask price, a last trade price, an index value, shares traded, change direction, change price, security symbol, etc. Pricing data can also include additional data related to the security, such as total trading volume, last trade volume, bid volume, ask volume, etc. Movement of a security or index can be determined by comparing the corresponding data in the current pricing data with an original price. The audio indicator can be a single note, a chord, a piece of music, etc. As the security moves in price, the audio indicator can change relative to the movement of the security's price. Over time, as the security's price changes, the ticker tile plays audio indicators associated with the price change, which can be considered the implicit melody of the security over the time period. This melody provides a user an audio indicator that describes the changes of a security's price.

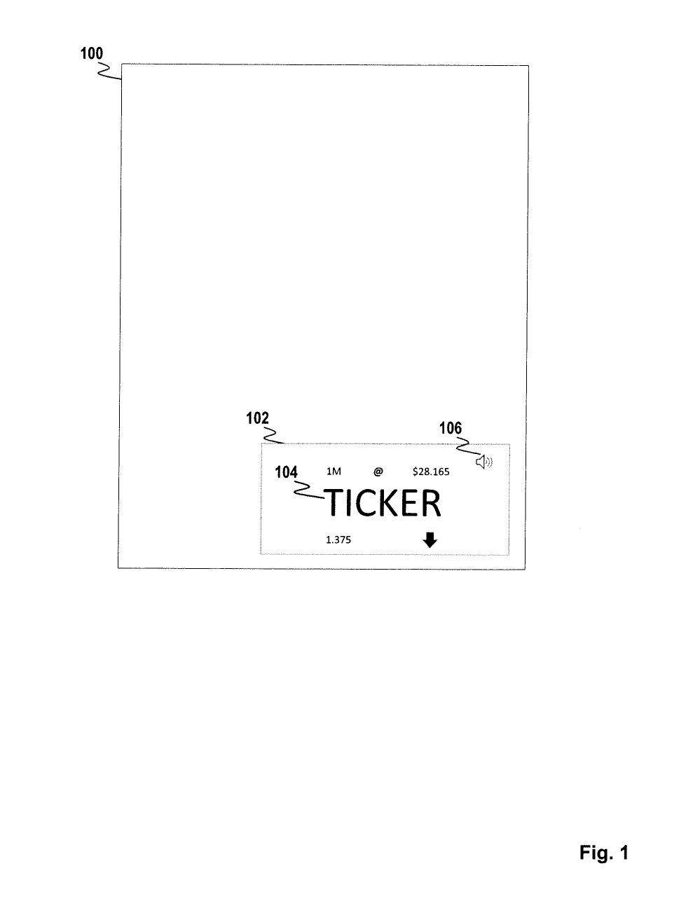

FIG. 1 illustrates a ticker tile 102 on a display 100 in accordance with an illustrative implementation. The ticker tile 102 is associated with a security or an index. An indication 104 of the security or index associated with the ticker tile 102 can be visually displayed on the ticker tile. The indicator can be a ticker symbol, a name of the security or index, an icon associated with the security or index, etc. The ticker tile 102 can also include other pricing data associated with the security, such as the last trade price, the day's trade volume, a change indicator, etc. In addition, the ticker tile 102 can include an audio indicator 106 that allows a user to mute and/or change the volume of the ticker tick 102. In addition, the ticker tile 102 can have a background color that changes based upon the pricing data. In one implementation, the background color is one of three colors that represent pricing data that is lower than the security's opening price, pricing data that is above the security's opening price, and pricing data that is the same as the security's opening price. As a specific example, the three colors can be red, green, and blue, respectively. In another implementation, a number of colors can be used based upon how far the current price has moved from an original price, e.g., the previous day's close price. For example, the initial color can be white, indicating no change from the original price. As the price goes down, the color can change to red depending on far from the original price the current price has moved. For example, when the price has fallen a predetermined amount, such as 1%, the color can be changed to a light red. When the price has further fallen to a predetermined amount, such as 5%, the color can be changed to a darker red. In one implementation, visual changes to the ticker tile may be associated with information regarding the security or index, such as trading volume or trending information from media, such as Twitter®. A ticker tile can be displayed in various ways. For example, a ticker tile can be a stand alone application, an icon, a widget, a tile, etc. How the ticker tile is displayed can be based upon the features of an underlying operating system.

Each ticker tile is associated with a security or index and an original price of the security or index. The original price can be an opening price, a previous close price, a price provided by a user, or a current price can be used as the original price. Using a current price as the original price allows a ticker tile to provide audio indicators associated with any time period, rather than an opening price. As another example, the original price can be set to a price that a security was purchased at, allowing the ticker tile to provide an audio indicator for a security within a portfolio. The original price can be set in various ways. For example, a user can explicitly provide the original price, double clicking on the ticker tile can reset to the original price from the current price. The ticker tile can retrieve the original price from a data source, such as, a remote server the provides pricing data. In another implementation, the original price can be updated over a period of time. For example, the original price can be set to the previous ask price of a security. This allows the ticker tile to provide an audio indicator on how the security is currently trending.

Once the original price is set, the ticker tile receives pricing data associated with the ticker tile's security or index. The ticker tile can request the pricing data associated with the security. For example, the ticker tile can request that a remote server stream pricing data for the ticker tile's security. In another implementation, the ticker tile can request pricing data according to a schedule. The ticker tile can then use the pricing data to provide audio indicators related to the security. The audio indicators can be pre-programmed or can be user selected. For example, a default set of notes or chords can be used as the audio indicator, but a user can personalize the audio indicators. The audio indicator to use can be determined when new pricing data is available and/or on a schedule. For example, every 3, 5, 10, etc., seconds, the ticker tile can determine which audio indicator to use.

In one implementation, the audio indicator can be one of three notes. The three notes correspond with pricing data above, below, or at the original price. For example, a middle C note can correspond with pricing data that is at the original price. A higher note and a lower note can be used to indicate pricing data that is above or below the original price, respectively. In another implementation, chords are used. A major chord can be used to indicate pricing data that is above the original price and a minor chord can be used to indicate pricing data that is below the original price. For pricing data that is equal to the original price, a single note, such as the root note of the major/minor chords can be used. In yet another implementation, a number of single notes can be used. For example, middle C can correspond with pricing data that is at the original price. The audio indicator for pricing data that is above the original price can be any note above middle C. The selected note can correspond to how far the pricing data is above the original price. For example, the difference between the current price and the original price can be calculated for a security and mapped onto one of the notes above middle C. The notes above middle C but in the same octave can represent the average daily variance in the security. The average daily variance can be calculated from historical pricing data. The average historical variance can be divided upon the six notes above middle C. Notes in higher octaves can also be used, but in this example, signify that the security has changed in price by an amount greater than the average historical variance.

In another implementation, the ticker tile can provide two or more audio indicators. For example, a first audio indicator based upon current pricing data compared to the original price as described above can be played. A second audio indicator, played either before or after the first audio indicator, can be based upon the current pricing data compared to the previous pricing data. For example, a security that is above the original price but is dropping, can play a first audio indicator, such as a major C-chord to indicate the current pricing data is above the original price, and then a second audio indicator, such as a minor-D chord to indicate the current pricing data is below the previous pricing data. In this example, the two audio indicators have separate original prices. In another implementation, the second audio indicator can be based upon a second security. For example, the first audio indicator can be based upon pricing data of a specific stock, option, etc., and the second audio indicator can be based upon pricing data of an index.

As described above, the audio indicator provides an indicator based upon pricing data of a security or index. Other data can also be encoded in the audio indicator to provide additional information via the audio indicator. The audio indicator can be played for a period of time that corresponds to the pricing data. For example, the length of the audio indicator can correspond to the difference between the original price and the current price. When the original price is the opening price, the length of the audio indicator would correspond to how far from the current price the audio indicator has moved. In this implementation, the audio indicator can include various notes and/or chords between an initial audio indicator and a final audio indicator. For example, if middle C is used to indicate that the pricing data corresponds to the original price and a C that is two octaves above middle C (high C) is used to indicate the current pricing data is higher than the original price, each note in the C scale can be played between middle C and the high C. The time it takes to reach the high C note can be an indicator of how far from the original price the current price is. For example, the length can be directly or indirectly proportional to the difference between the current price and the original price.

Other qualities of the audio indicator, such as the tempo, volume, etc., can be used to convey data regarding the ticker tile's security or another security and/or index. For example, the tempo can be used to convey the trading volume of the security. As another example, the volume can indicate if the last trade is above, below, or the same as the current price. Each of the various qualities can be used to encode different data. As a specific example, a ticker tile can be associated with a particular stock. The original price can be set to the stock's opening price and a first audio indicator can indicate if the current ask price for the stock is above, below, or the same as the original price. The length of the first audio indicator can correspond to the volume associated with the current ask price. A second audio indicator similar to the first audio indicator, but directed to the bid price can be used. Thus, the second audio indicator can indicate if the current bid price for the stock is above, below, or the same as the original price. The length of the second audio indicator can correspond to the volume associated with the current bid price. Certain properties of the audio indicators can be based upon the same data. For example, the volume of both audio indicators can correspond to the last trade amount. In addition, audio properties of the audio indicators can be used to convey information about another security. For example, the tempo of both the first and second indicator can be used to indicate if an index is either higher, lower, or the same compared to its opening price. Continuing the current example, the ticker tile can set the tempo of the audio indicators based upon the pricing data of a market index that includes the ticker tile's security.

A ticker tile can produce its audio indicators using various synthesized instruments. For example, the audio indicators can correspond to a piano, a guitar, harp, steel drums, etc. The various notes or chords, as described above, can be played on the instrument associated with a particular ticker tile. In another implementation, the instrument can be a drum. When a drum or other similar type of percussive instrument is selected, the audio indicators can correspond to notes or other sounds associated with the instrument. For example, a snare hit can correspond with higher pricing data, a bass drum hit for lower pricing data, a high tom hit for the same pricing data.

Additional audio indicators can be included based upon the pricing data. For example, one or more cymbal crashes can be used to indicate each time the pricing data indicates a predetermined percentage loss, such as, 3, 5, 10%, for a security or index has occurred. As another example, a series of notes can be played when the security reaches a predetermined price. Other market or trading events can also trigger an audio indicator. For example, an audio indicator can be based upon data from a trading platform. In this example, an audio indicator can play when a conditional order is executed.

In another implementation, the audio indicators are based upon a known piece of music. For example, the melody of a known piece of music, such as Beethoven's Moonlight Sonata, can be used. Each audio indicator can be a successive note or chord in the melody of the music. The note, however, can be changed from the original piece of music based upon the pricing data. In one implementation, a note is not changed if the current pricing data is unchanged compared to the original price. The note can be moved up or down one or more notes if the current pricing data is above or below the original price, respectively. For example, the note can be moved up a single note based upon the current pricing data. In this implementation, the audio indicators will resemble a known piece of music, but will be altered to provide an indication of the security's current price. In another implementation, the tempo or volume of each note can change corresponding to the current pricing data. In one implementation, one or more audio indicators can be a sample or clip of music. In this implementation, an sample or clip can be associated with audio indicator triggers, for example, negative price change, positive price change, neutral price change, price reaches a predetermined price, etc.

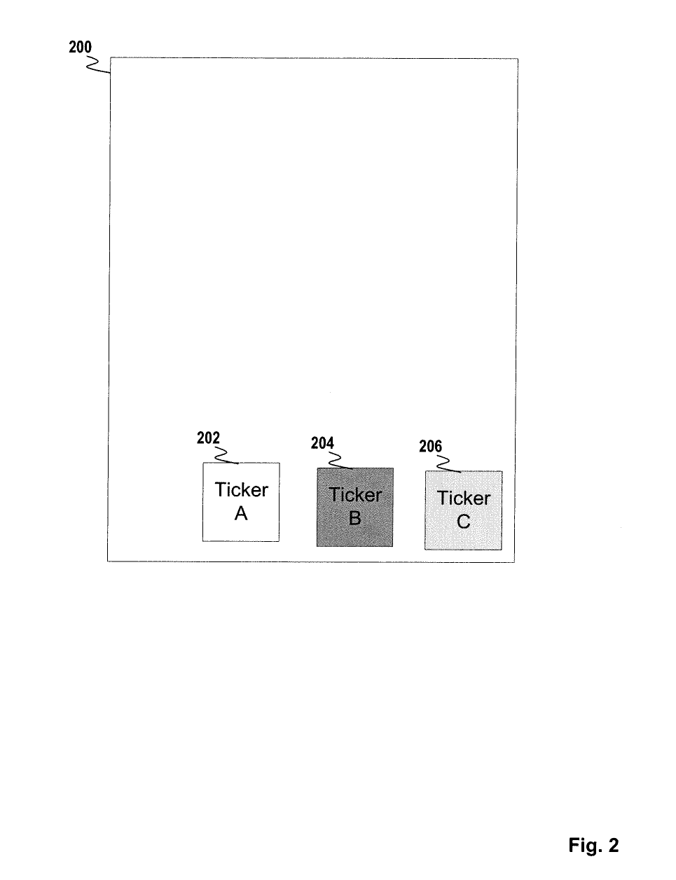

In another implementation, multiple ticker tiles can be used at once. FIG. 2 illustrates multiple ticker tiles on a display 200 in accordance with an illustrative implementation. Each ticker tile 202, 204, and 206 can be implemented as described above, and can provide audio indicators for different securities and/or indexes. In one implementation, each ticker tile 202, 204, and 206 has a different instrument. This allows the various audio indicators of the ticker tiles 202, 204, and 206 to be played concurrently. Thus, the audio indicators from the combined ticker tiles 202, 204, and 206 present pricing data as a musical ensemble.

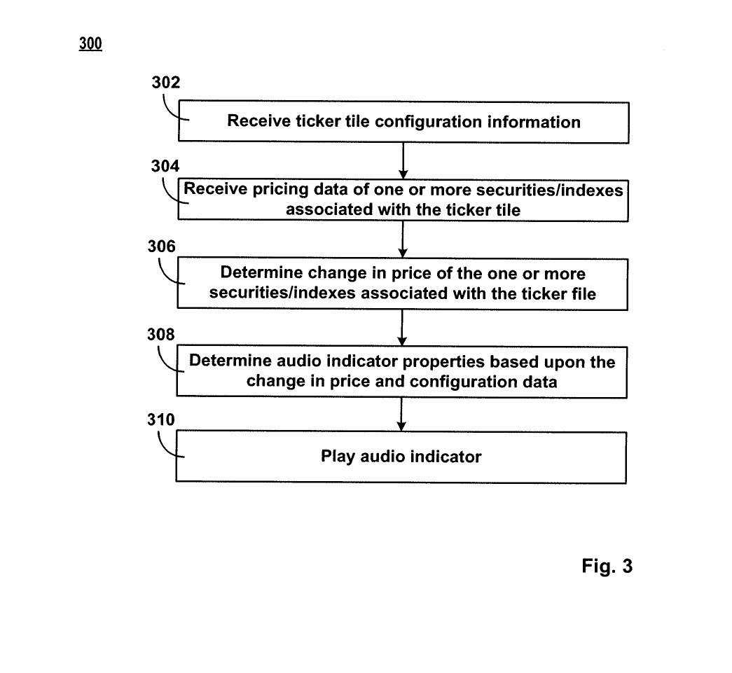

FIG. 3 is a flow diagram of a process 300 for providing an audio indication in accordance with an illustrative implementation. Additional, fewer, or different operations may be performed, depending on the particular embodiment. The process 300 can be implemented on a computing device. In one implementation, the process 300 is encoded on a computer-readable medium that contains instructions that, when executed by a computing device, cause the computing device to perform the process of 300.

Configuration information for a ticker tile is received by a computing device (302). The configuration data can include an indication of a security or index, an indication of the price of the security that the audio indicator is based on, and the type of audio indicator to use. As described above, the price of the security can be one of a bid price, an ask price, a market price, etc. Additional information, such as an original price, a piece of music, an instrument used to play the audio indicator, etc., can be received from a remote computing device, such as a pricing data provider, trading platform, etc. Other configuration information can include additional security and/or index indicators, audio indicator volume information, audio indicator tempo information, etc., and can also be received to configure a ticker tile. Once configured, the ticker tile can receive pricing data associated with the securities indicated in the configuration information (304). The pricing data can be streamed to the ticker tile or the ticker tile can request the pricing data at various times. Using the pricing data and the original price, a change in price of the security or index is determined (306). Based upon the change in price and the configuration information, the properties of the audio indicator is determined (308). For example, what note or chord, the volume, the length, and/or the tempo of the audio indicator can be determined. In addition, the color of the ticker tile can be determined based upon the pricing data and configuration information. Once the audio indicator is determined, the audio indicator is played (310). For example, the audio indicator can be played through speakers of the computer device. The color of the ticker tile can also be changed as described above concurrently with the playing of the audio indicator. In some implementations, a second change in price can be calculated based upon the security or index of another, different security or index. This second price change can be used to determine a second audio indicator. The second audio indicator can be played concurrently with, immediately before, or immediately after the first audio indicator.

In one implementation, the ticker tile is associated with an option. For example, the audio indication is associated with the profitability of the option, such as a particular instrument or note being an indication that the option is “in the money”. In another example, the audio indication is associated with the underlying security for the option associated with the ticker tile.

In other implementations, a ticker tile can incorporate a chart based upon the pricing data. For example, the ticker tile can display a chart of a securities price over a time period, such as the current day, last quarter, last year, etc. In another implementation, audio indicators are used to audibly convey a chart's data using the configured audio indicators of a ticker tile. For example, a user can view a financial chart regarding a security. In one example of using audio indicators with a financial chart, an icon or link can be used to activate the audio indicator. For example, the various data points on the chart can be used to determine the audio properties of the audio indicator for each data point. The audio indicator can then be played for each data point, thus, audibly rendering the chart. The various properties of the audio indicator can be configured for each data point, as described above, based upon data displayed in the chart and/or pricing data associated with the charted security and/or the data point. In some implementations, a visible indicator can move along the chart to indicate which data point was used for the currently playing audio indicator. As described above, there can be multiple ticker tiles that are playing simultaneously. A chart that includes data from multiple securities can also have multiple audio indicators playing simultaneously, e.g., one audio indicator per charted security.

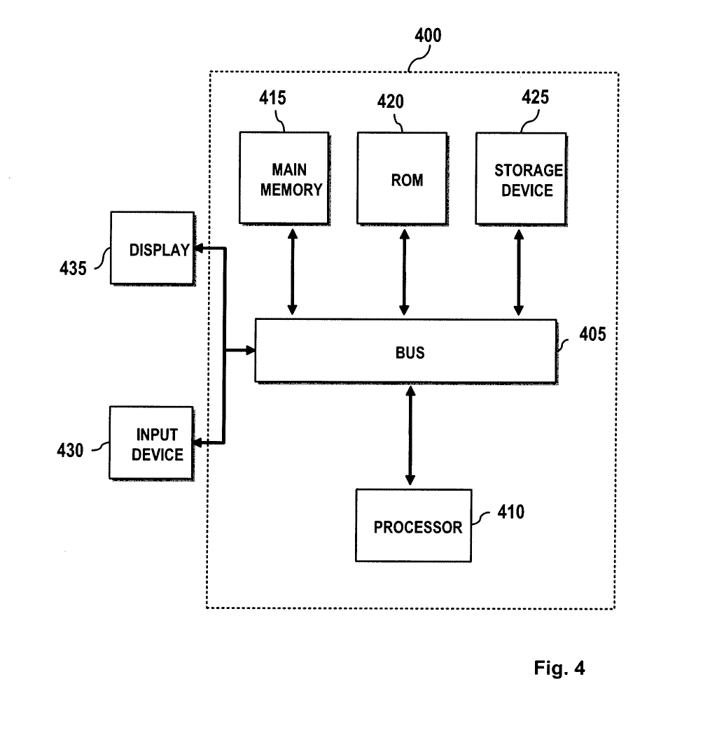

FIG. 4 is a block diagram of a computer system in accordance with an illustrative implementation. The computer system or computing device 400 can be used to implement cell phones, clients, servers, cloud computing resources, etc. The computing system 400 includes a bus 405 or other communication component for communicating information and a processor 410 or processing circuit coupled to the bus 405 for processing information. The computing system 400 can also include one or more processors 410 or processing circuits coupled to the bus for processing information. The computing system 400 also includes main memory 415, such as a random access memory (RAM) or other dynamic storage device, coupled to the bus 405 for storing information, and instructions to be executed by the processor 410. Main memory 415 can also be used for storing position information, temporary variables, or other intermediate information during execution of instructions by the processor 410. The computing system 400 may further include a read only memory (ROM) 410 or other static storage device coupled to the bus 405 for storing static information and instructions for the processor 410. A storage device 425, such as a solid state device, magnetic disk or optical disk, is coupled to the bus 405 for persistently storing information and instructions.

The computing system 400 may be coupled via the bus 405 to a display 435. An input device 430, such as a keyboard, may be coupled to the bus 405 for communicating information and command selections to the processor 410. In another implementation, the input device 430 has a touch screen display 435. The input device 430 can include a cursor control, such as a mouse, a trackball, or cursor direction keys, for communicating direction information and command selections to the processor 410 and for controlling cursor movement on the display 435.

According to various implementations, the processes described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors in a multi-processing arrangement may also be employed to execute the instructions contained in main memory 415.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Moreover, the separation of various system components in the implementations described above should not be understood as requiring such separation in all implementations, and it should be understood that the described program components and systems can generally be integrated in a single software product or packaged into multiple software products.

Similarly, while operations are depicted in the drawings in a particular order, this should not be understood as requiring that such operations be performed in the particular order shown or in sequential order, or that all illustrated operations be performed, to achieve desirable results. Thus, particular implementations of the subject matter have been described. Other implementations are within the scope of the following claims.

What is claimed is:

1. A method comprising:
receiving, at a processor, configuration data comprising an indication of a first security or index, an original price of the first security or index, and a first audio indicator type;
receiving pricing data of the first security or index;
determining a change in price of the first security or index based upon the received pricing data and the original price;
determining a first audio property of a first audio indicator based upon the change in price and the first audio indicator type; and
playing the first audio indicator.

2. The method of claim 1, wherein determining the first audio property of the first audio indicator comprises determining one or more notes of the first audio indicator based upon the pricing data.

3. The method of claim 2, wherein determining one or more notes of the first audio indicator based upon the pricing data comprises:
determining a major chord when a corresponding price in the pricing data is above the original price; and
determining a minor chord when the corresponding price in the pricing data is below the original price.

4. The method of claim 2, wherein determining one or more notes of the first audio indicator based upon the pricing data comprises:
determining a first note when the original price is the same as a corresponding price in the pricing data;
determining a second note, higher than the first note, when the original price is above the corresponding price in the pricing data; and
determining a third note, lower than the first note, when the original price is below the corresponding price in the pricing data.

5. The method of claim 4, wherein the first note corresponds with a melody in a piece of music.

6. The method of claim 1, further comprising updating the original price based on the pricing data.

7. The method of claim 1, further comprising determining a second audio property of the first audio indicator based on security or index information, wherein the second audio property corresponds with one of a tempo, length, or volume.

8. The method of claim 7, wherein the second audio property is based upon one of a trading volume, an opening price, or a last trade price of the first security or index.

9. The method of claim 1, further comprising:
determining a second change in price of a second security or index;
determining second audio properties of a second audio indicator based upon the second change in price and a second audio indicator type; and
playing the second audio indicator.

10. The method of claim 9, further comprising receiving pricing data of the second security or index, wherein the second security or index is different than the first security or index.

11. The method of claim 9, wherein the second audio indicator is played concurrently with the first audio indicator.

12. The method of claim 11, wherein the first audio indicator is played using a first synthesized instrument and the second audio indicator is played using a second synthesized instrument.

13. The method of claim 1, wherein the change in price corresponds to one of a change of a bid price, an ask price, and a last transaction price.

14. The method of claim 1, further comprising changing a color of a ticker tile associated with the first audio indicator based upon the change in price.

15. The method of claim 1, further comprising:
producing a chart based upon the pricing data of the first security or index; and
displaying the chart within a ticker tile associated with the first audio indicator.

16. A system comprising:
one or more electronic processors configured to:
receive configuration data, wherein the configuration data comprises an indication of a first security or index, an original price of the first security or index, and a first audio indicator type;
receive pricing data of the first security or index;
determine a change in price of the first security or index based upon the received pricing data and the original price;
determine a first audio property of a first audio indicator based upon the change in price and the first audio indicator type; and
play the first audio indicator.

17. The system of claim 16, wherein the first audio property of the first audio indicator is determined by the one or more processors configured to determine the first audio property of the first audio indicator comprises determining one or more notes of the first audio indicator based upon the pricing data.

18. The system of claim 17, wherein the one or more notes of the first audio indicator are determined by the one or more electronic processors configured to:
determine a first note when the original price is the same as a corresponding price in the pricing data;
determine a second note, higher than the first note, when the original price is above the corresponding price in the pricing data; and
determine a third note, lower than the first note, when the original price is below the corresponding price in the pricing data.

19. The system of claim 16, wherein the one or more electronic processors are further configured to:
determine a second change in price of a second security or index;
determine second audio properties of a second audio indicator based upon the second change in price and a second audio indicator type; and
play the second audio indicator.

20. A non-transitory computer-readable medium having instructions stored thereon, the instructions comprising:
instructions to receive configuration data, wherein the configuration data comprises an indication of a first security or index, an original price of the first security or index, and a first audio indicator type;
instructions to receive pricing data of the first security or index;
instructions to determine a change in price of the first security or index based upon the received pricing data and the original price;
instructions to determine a first audio property of a first audio indicator based upon the change in price and the first audio indicator type; and
instructions to play the first audio indicator.
